(19) United States
(12) Patent Application Publication
(10) Pub. No.: US 2008/0119977 A1
(43) Pub. Date: May 22, 2008

(54) Control Unit and Computer Program For Controlling a Drive Assembly of a Vehicle

(76) Inventor: Bjoern Beuter, Hirrlingen (DE)

Correspondence Address: KENYON & KENYON LLP, ONE BROADWAY, NEW YORK, NY, 10004, US

(21) Appl. No.: 10/546,627

(22) PCT Filed: Feb. 19, 2004
(86) PCT No.: PCT/EP04/50165

§ 371 Date: Jan. 14, 2008

(30) Foreign Application Priority Data
Feb. 21, 2003 (DE) 103-07-698.0

(51) Int. Cl. B60W 50/00; G05B 19/042; G01M 17/007

(52) U.S. Cl. 701/29; 701/115; 701/1

(57) ABSTRACT

A control unit and a computer program for controlling a drive assembly, of a vehicle. Traditionally, in such a control unit, numerous functional units are provided, for instance, a functional unit drive, engine coordinator, diagnosis manager, etc. In the case especially of a change in the drive assembly that is to be activated by the control unit, in order to have to replace not all, or a large part of the functional units, but only the functional units relevant for the new drive assembly, a modularization of these functional units is proposed. This modularization provides, in particular, that those functional units are combined which make possible individual programming of the hardware of the control unit in such a way that the hardware is put in a position to communicate with the modules of the control unit.

### FIELD OF THE INVENTION

The present invention relates to a control unit and a computer program for controlling a drive assembly, especially of an internal combustion engine of a vehicle.

### BACKGROUND INFORMATION

Control units and appertaining computer programs are known in principle in the related art. FIG. 9 shows such a known control unit, reference symbol 100a representing the hardware and reference symbol 100b the software of control unit 100. The hardware of control unit 100 includes at least one processor 100a-1 and at least one memory element 100a-2. Software 100b is usually stored in memory element 100a-2. In the related art, software 100b usually includes a plurality of functional units VF-1, EF-3, IS-2, HWE-1, HWE-3 and VF-3, which at least singly communicate with one another for the purpose of activating drive assembly 300. The immediate control of drive assembly 300 takes place with the aid of a sensor/actuator configuration 200 that is connected between control unit 100 and drive assembly 300.

Some functional units in software 100b for a control unit 100 for controlling a drive assembly are, for example:
Functional Unit Drive VF-1: It organizes the sources of mechanical energy and makes available for the drive assembly a setpoint torque for the propulsion of the vehicle and for supply of the accessories, usually after stipulation by a functional unit vehicle coordinator.
Functional Unit Vehicle Coordinator VF-2: It makes decisions on the collaboration of various functional units, including other ones. For example, it decides what torque the functional unit drive should set on the drive assembly if various other functional units in each case require different torque quantities to be set at the drive assembly.
Functional Unit Vehicle Movement VF-3: It compares a current movement with the driver's command, with respect to ensuring an optimal vehicle stability. This includes, for instance, the evaluation of the driver's command according to his actions at the gas pedal and the brake pedal, as well as the coordination of this driver's command with stipulations of safety systems, such as an electronic stability program ESP or anti-slip control ASC.
Functional Unit Vehicle State Quantities VF-4: It manages the data on current driving conditions, such as stop & go, driving uphill, etc, independent of which functional unit is determining these driving conditions.
Functional Unit Engine Coordinator EF-1: It is the engine coordinators's task to coordinate all the operating conditions and to make available data concerning the engine operating state.
Functional Unit Engine Coordinator EF-2: This functional unit has the task of ascertaining the torque requirements of other functional units of the engine, and to coordinate and to determine a resulting requirement on torque conversion.
Assembly Position Management EPM: This functional unit has the task of carrying out position recording and rotary speed recording of the crankshaft and camshaft of the drive assembly.
Functional Unit Services Library IS-1: It has the task of making available general, very frequently occurring functions which are requested or used by different functional units. It is used for making centrally available these functions, with the advantage that they do not have to be made available multiple times in decentralized fashion.
Functional Unit Sequence Control IS-2: It coordinates the processing in time of requirements of different functional units.
Functional Unit Diagnosis Manager IS-3: This functional unit takes on the preparation of an error signal which, for instance, represents a defect in hardware 100a of control unit 100. The preparation consists especially in a debounce of the error signal and storage of the same, so that at a later point in time an evaluation of the error signal is able to take place.
Functional Unit Monitoring Concept IS-4: This functional unit is used particularly for monitoring the processor of the control unit.
Functional Unit Signal Preparation HWE-1: It carries out the clearing up of an analogous sensor signal after its digitalization with respect to undesired signal modulations which might possibly have been created in the control unit.
Functional Unit Gas System EF-3: It has the central task of supplying data concerning the current air mass that is available to drive assembly 300, and, within the scope of its influence possibilities on the drive assembly, of monitoring or setting a desired setpoint air mass and/or the exhaust gas quality. This functional unit gas system is used particularly with Diesel engines or gasoline engines.
Functional Unit Injection System EF-4: It makes available all the functions required for fuel presupply, injection pressure generation and injection.

Individual ones of these known functional units are shown in exemplary fashion in FIG. 9 within software 100b of the control unit. However, they were not all developed at the same time and implemented in software 100b, but were added to the software of control unit 100 only in the course of time, successively during the course of advancing development. In adding new functional units, up to this point, people paid attention only to having the new functional units be able to communicate with all other functional units to the extent that this was required. Thus, during the course of time, an unclear agglomeration of interfaces was created between the individual functional units, which particularly made increasingly difficult a replacement of known functional units by modified functional units, or the further addition of new functional units. The difficulties were created particularly because existing dependencies among individual functional units were able to be grasped only with great difficulty when there was a revamping of the overall system or even just parts of it.

### SUMMARY OF THE INVENTION

Starting from this related art, it is an object of the present invention further to develop a known control unit and a computer program for controlling a drive assembly of a vehicle in such a way that individual parts of the control unit, and especially of its software, are able to be implemented independently of each other and to be replaced.

According to the present invention, for a known control unit described above, a modularization is provided in the form of at least three modules, in a first module, those functional units being combined which are used for influencing the drive assembly in response to a user command on a physical plane, in a second module, those functional units being combined which make possible an individual programming of the hardware of the control unit in such a way that the hardware is put in a position of communicating with the modules of the control unit and which coordinate in time the processing of functions of the functional units in the modules and in a third module, those functional units being combined which make possible an individual adjustment of the sensor/actuator configuration to the control unit in such a way that between the individual sensors or actuators of the configuration communication is possible with the remaining modules of the control unit; and between the modules, module interfaces being provided for a module-overlapping communication.

The drive assembly, in the meaning of the present invention, may represent alternatively an internal combustion engine and also, for instance, an electrical drive or a fuel cell drive.

The user in the sense of the present invention may, for instance, be the driver of the vehicle, the legislator, a vehicle supplier or a vehicle manufacturer.

Physical level, in the sense of the present invention, refers to an abstraction of hardware specifics. This means that, on the physical level, with reference to the interface of the sensor with its surroundings, only physical variables, such as the rotary speed of the drive assembly, are being considered, but not their implementation in hardware in the form of an electronic signal having a hardware-specific amplitude representing the rotary speed.

Advantage of the modularization is that the individual modules are easily replaceable and may be implemented independently of one another. In this context, the subdivision of the functional units into the individual modules was selected in such a way that it makes sense particularly from the point of view of the vehicle's manufacturer and from a physical point of view. Replacement of individual modules is especially simple particularly because, in the specified module interfaces between the individual modules, all the dependencies between the functional units in the various modules have been taken into consideration, and dependencies going beyond this may exist, to be sure, even at the level of the functional units, but no longer exist at the level of the modules, and therefore no longer have to be considered when replacing the modules.

Cost savings and time savings are particularly connected with the proposed modularization. When using another control unit hardware or another sensor/actuator configuration, one no longer has to replace or adjust the entire software of the control unit, but rather it is sufficient if only the respective module is replaced.

According to a first exemplary embodiment, it is advantageously proposed to subdivide the first module into a vehicle component and into a drive assembly component. According to a second exemplary embodiment, it is proposed to subdivide the second module into an infrastructure component and into a hardware capsule, as well as, optionally in addition, also into a communications component.

In summary, it should be observed, in connection with the above-named exemplary embodiments, that the subdivision of the individual modules into components, similarly as in the case of the modules, is used to improve the replaceability of the components.

Advantageously, between the components within a module, interfaces for a rapid data exchange are also provided. On the other hand, a communication between components in different modules takes place via the module interfaces. Each of the components is, on its part, again subdivided into any number of functional units. Interfaces are also provided on the level of these functional units, so that various functional units within one component are able to communicate with one another. A communication between functional units in different components takes place via the component interfaces, and a communication between functional units in different modules takes place via the module interfaces. What was said above for the module interfaces applies also for the interfaces between the functional units, namely, that in these interfaces all the required dependencies between the functional units or the components among one another have been taken into consideration, and in each case additional dependencies do not have to be considered. The result of this is a simple replaceability not only of modules, but also of components or functional units, which means, in particular, a simple and uncomplicated adjustment to customer requests or new technologies.

According to one advantageous development, the functional units, the components and/or the modules, as well as their respective interfaces, are developed at least partially as a computer program. The development as computer program permits a flexible conversion of change commands without a change in the hardware of the control unit having to be undertaken.

Furthermore, the above-named object is attained by a computer program for the described control program. The advantages of this computer program correspond to the advantages mentioned above with reference to the control program.

Further advantages result from the following description.

### BRIEF DESCRIPTION OF THE DRAWINGS

FIG. 1 shows a modular architecture for a control unit according to the present invention.

FIG. 2 shows a subdivision according to the present invention of the modules into components.

FIG. 3 shows an allocation, according to the present invention, of functional units to a vehicle component and a drive assembly component.

FIG. 4 shows the allocation, according to the present invention, of functional units to an infrastructure component and a hardware capsule component.

FIG. 5 shows a functional unit for a device driver element.

FIG. 6 shows an illustration of interfaces between the modules.

FIG. 7 shows an interface between two functional units in different components.

FIG. 8 shows an example for a data flow between the modules.

FIG. 9 shows the layout of a control unit according to the related art.

FIG. 10 shows the embedding of an interface architecture into the modular architecture.

FIG. 11 shows the layer representation of a selected interface.

### DETAILED DESCRIPTION

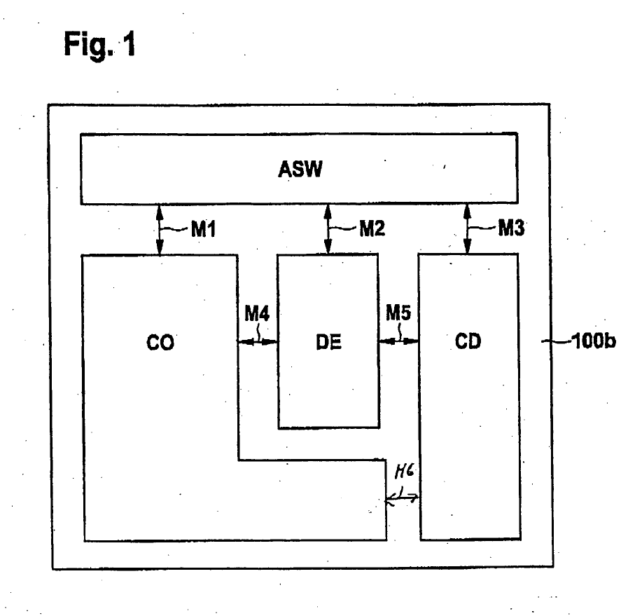

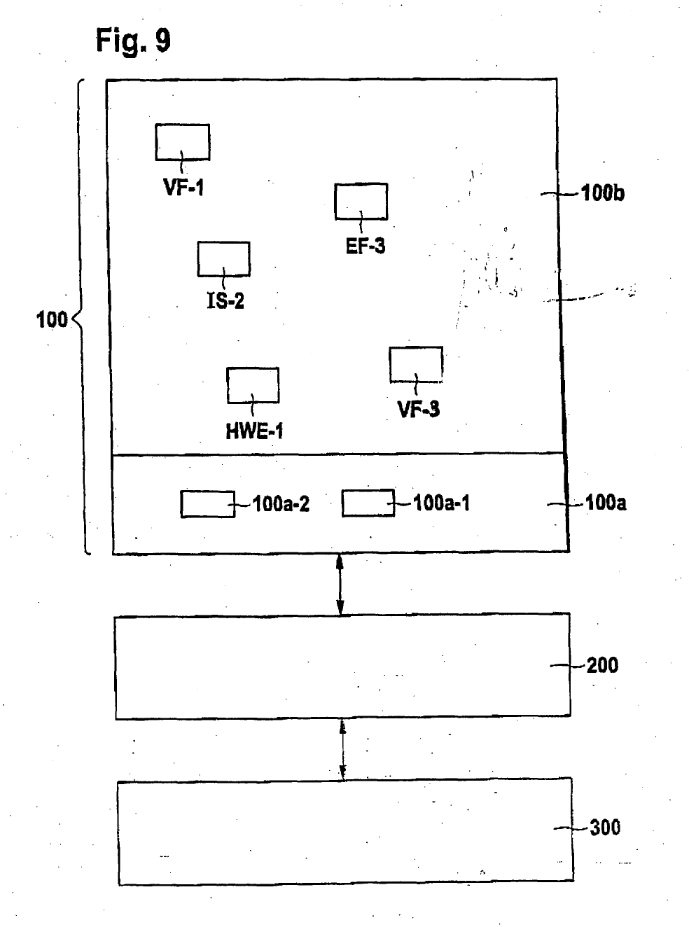

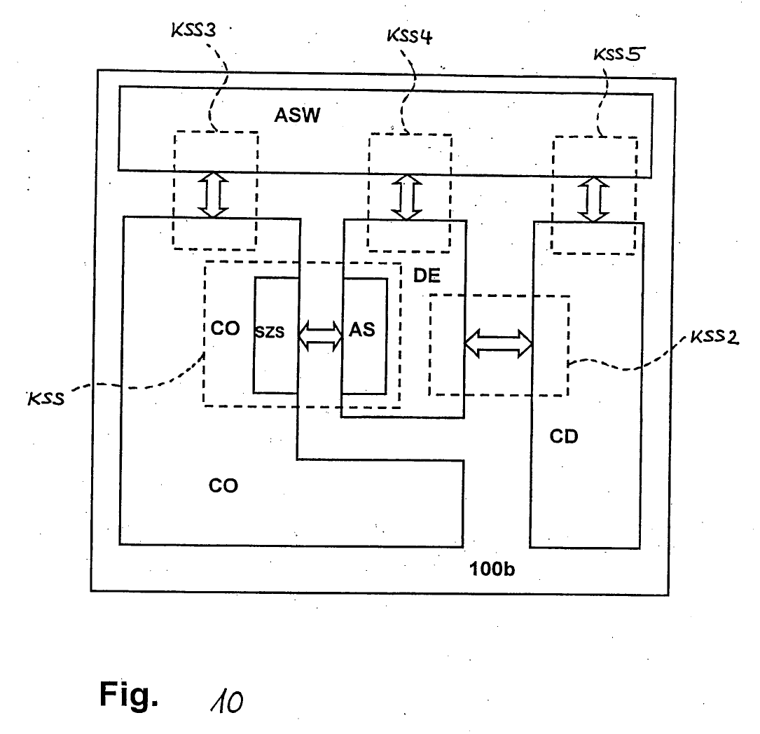

FIG. 1 shows, with reference to FIG. 9, a modularization, according to the present invention, of functional units in a control unit 100 for controlling a drive assembly 300, especially an internal combustion engine, of a vehicle. In contrast to FIG. 9, in FIG. 1 only the structure of the content of memory element 100a-2 is shown; in particular, the sensor/actuator configuration 200 and drive assembly 300 are not subject matter of the present invention, and are therefore not further described below.

According to the present invention, it is proposed that the functional units in control unit 100 be grouped into four separate modules.

In a first module ASW, those functional units are combined which are used for influencing drive assembly 300 in response to a user command on a physical level.

In a second module CO, first of all, those functional units are combined which make possible an individual programming of the hardware of control unit 100 in such a way that the hardware is put in a position of communicating with the modules of control unit 100. In addition, second module CO includes those functional units which coordinate processing functions of the functional unit in the modules ASW, CO, DE, CD over time. In addition, second module CO may also have such functional units as make possible communication of module ASW and/or a third module DE with other control units.

In a third module DE those functional units are combined which make possible an individual adjustment of the sensor/actuator configuration used to control unit 100 in such a way that, between the individual sensors or actuators of the configuration a communication is possible with the remaining modules of control unit 100.

Finally, in a fourth model CD, those functional units are combined which make possible a direct activation of complex sensor/actuator configurations having complex interfaces to control unit 100 by the first module. These special sensor/actuator configurations are to be distinguished from the aforementioned, non-special sensor/actuator configurations. In contrast to non-specific configurations in which communication with the first module is only via the second and the third module, in the special configurations there takes place a communication with the first module, directly via the fourth module.

Between modules ASW, CO, DE, CD, respective module interfaces M1, M2, M3, M4, M5 and M6 are provided which, first of all, make possible communication of the modules among one another, but also the replacement of individual modules.

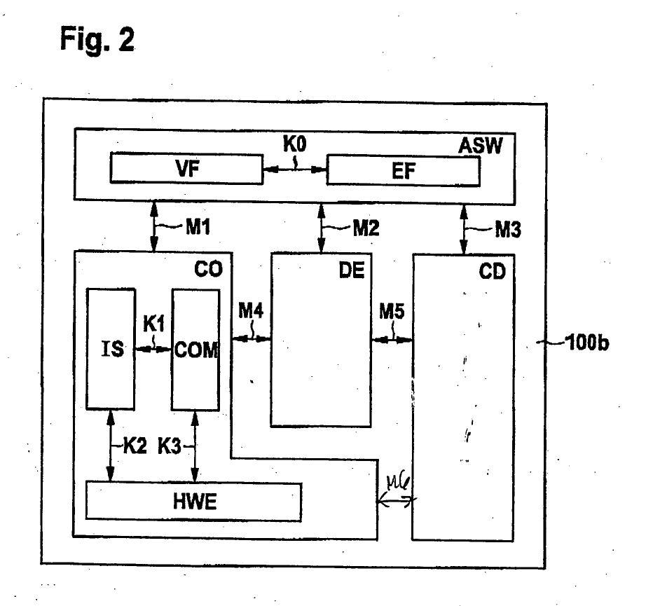

FIG. 2 shows a grouping, according to the present invention, of components within previously described modules ASW, CO and CD. First module ASW essentially represents applier-oriented or user-oriented functions. In view of planned application cases in which different types of drive assemblies are to be activated by the control unit, it makes sense to subdivide this first module ASW into a vehicle component VF and a drive assembly component EF. The vehicle component preferably includes those functional units which are not specific for a certain type of drive assembly 300. In this context, in particular, functional units drive VF-1, vehicle coordinator VF-2, vehicle motion VF-3 or driving state variables VF-4 are involved, as described at the outset.

As against this, in drive assembly component EF, preferably, all those functional units are combined which are specific for the type of drive assembly 300 used. In this context, preferably functional units engine coordinator EF-1, engine torque structure EF-2, gas system EF-3 or injection system EF-4 are involved, as was described above with reference to FIG. 9. If there is a change in drive assembly 300 that is to be activated by control unit 100, it is then no longer necessary to replace the complete first ASW module, but rather, it is enough advantageously if only drive assembly component EF is replaced.

Similarly to the case of the first module, it is recommendable in the case of the second module, for example, with regard to another processor to be used in control unit 100, to subdivide the second module into an infrastructure component IS and into a hardware capsule component HWE. In infrastructure component IS, preferably all those functional units are combined which offer or represent basic services, which other functional units are able to access. In this context, preferably the functional units services libraries IS-1, sequence control IS-2, diagnosis manager IS-3 and monitoring concept IS-4 are involved, as was also described above. The services are made available in the infrastructure component at a central location, and therefore do not have to be present decentralized in multiple versions and unnecessarily take up storage space.

In hardware capsule component HWE, all those functional units are combined which make possible an individual programming of hardware 100a of control unit 100 in such a way that hardware 100a is put in a position to communicate with modules ASW, CO, DE or CD of control unit 100. Thus, if there is a replacement of the processor being used in the control unit by a processor of another type, it is only necessary to replace hardware capsule component HWE, and no longer the entire second module of the control unit.

Besides the infrastructure component named and the hardware capsule component, second module CO may, in addition, have a communications component COM, in which those functional units are combined which make possible communication with other control units.

Besides the aforesaid module interfaces M1 . . . M6 at module level, component interfaces at the level of the components are also provided within the individual modules. These component interfaces KO . . . K3 make possible a data exchange between at least individual ones of the components within a module. Thus, there is an interface KO in the first module between vehicle component VF and drive assembly component EF. Within a second module there is a component interface K1 between infrastructure component IS and communications component COM, a second interface K2 between infrastructure component IS and hardware capsule component HWE, and a third interface K3 between hardware capsule component HWE and communications component COM.

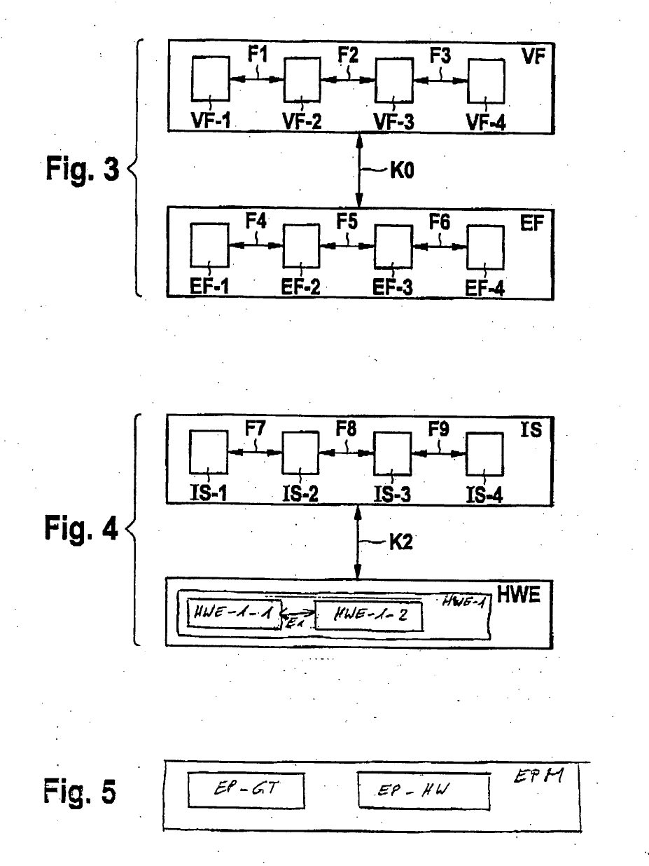

In FIG. 3 there is shown the already mentioned allocation of functional units to vehicle component VF and to the drive assembly component, as well as interface KO between the two components. In addition, it may be seen that the functional units within a component are able to communicate among one another via functional unit interfaces Fi, with i=1-9 Communication between functional units, which are allocated to different components within the same module, takes place via the said component interface, in this case KO. FIG. 4 shows the already described allocation of functional units to infrastructure components IS and hardware capsule component HWE within the second module. The statements already made with reference to FIG. 3 regarding the interfaces between the functional units and the comments are correspondingly valid in this case too. Alternatively or additionally to the development, shown in FIGS. 3 and 4, of the functional unit interfaces between the functional units within a component, these interfaces may also be developed in such a way that there is a direct connection to each functional unit within a component. For communication between, for example, functional unit services libraries IS-1 and functional unit diagnosis manager IS-3 it would then not be necessary to communicate via functional unit sequence control IS-2, but rather, a direct connection would be available.

For functional units HWE-1 . . . N of HWE it is advantageous to subdivide these in each case into a processor level element and a hardware abstraction level element. This subdivision offers the advantage that, for a desired replacement of the processor, not the entire hardware capsule component HWE but only the processor level elements have to be replaced, then, however, for all functional units of hardware capsule component HWE. By analogy, in the case of a desired replacement of the peripheral hardware of the control unit, that is the hardware of the control unit except for the processor, it is also no longer necessary to replace the entire hardware capsule component HWE, but rather, a replacement of the hardware abstraction level elements is sufficient for all the functional units of the HWE.

One functional unit allocated to hardware capsule component HWE is the functional unit signal preparation HWE-1, which was described in the introduction. For functional unit signal preparation HWE-1, processor level element HWE-1-1 takes on the signal preparation insofar as it relates to the processor type used, and hardware abstraction level element HWE-1-2 takes on the signal preparation insofar as it relates to the peripheral hardware used in the control unit.

Furthermore, interfaces Ek are provided for communication of processor level elements HWE-1-1 and hardware abstraction level element HWE-1-2 with each other and/or with superordinated functional units HWE-1 in HWE.

FIG. 5 illustrates the already mentioned advantageous subdivision of fourth module CD into several functional units; with reference to the fourth module, these are also called complex unit driver CD-i, with i=1 . . . N. Each of these complex unit drivers is, in turn, advantageously subdivided into a unit driver element CD-GT and into a hardware driver element CD-HW. Elements CD-GT are connected to first module ASW via interface M3. Via this interface M3 software signals are transmitted which represent a physical variable as, for instance, the injection quantity or the rotary speed. When unit driver elements CD-GT receive such a software signal from first module ASW, they convert it into another software signal which is specific for an actuator that is to be activated, but is still nonspecific for the control unit hardware. In the opposite case, if unit driver elements CD-GT receive such a different software signal from a hardware driver element CD-HW, they convert it into a software signal which represents only a physical variable, but is no longer specific for a sensor by which it was originally generated. Hardware driver elements CD-HW are used for the direct linking of special sensor/actuator configuration 200 to the control unit hardware, particularly to used processor 100a-1. Between unit driver elements CD-GT and the appertaining additional hardware driver elements CD-HW, in each case interfaces Ei, where i=1 . . . N, are provided.

One of the complex unit drivers is the functional unit described in the introduction, namely, assembly position management EPM. For the sake of a clear allocation, its unit driver element and its hardware driver element are given reference symbols CD_{EPM}-GT and CD_{EPM}-HW.

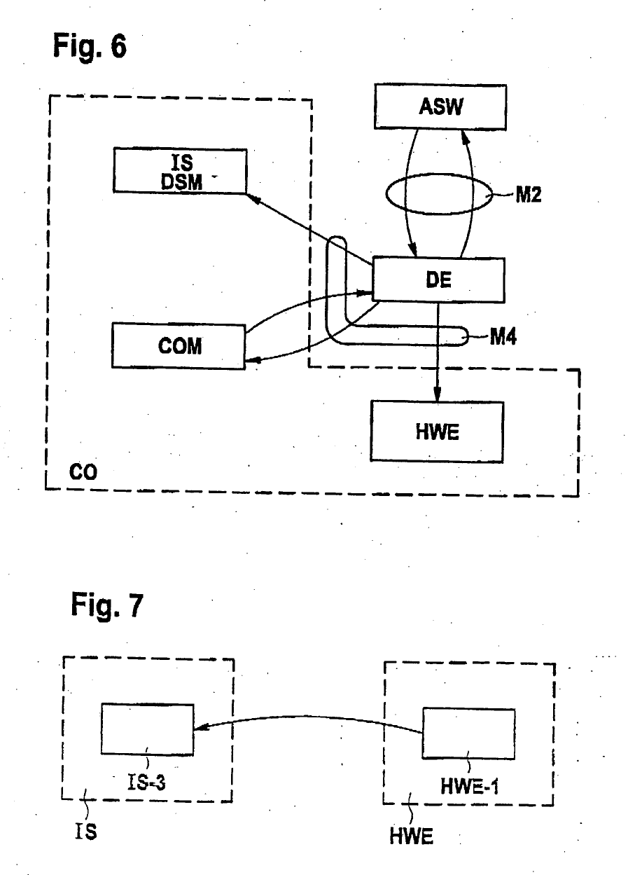

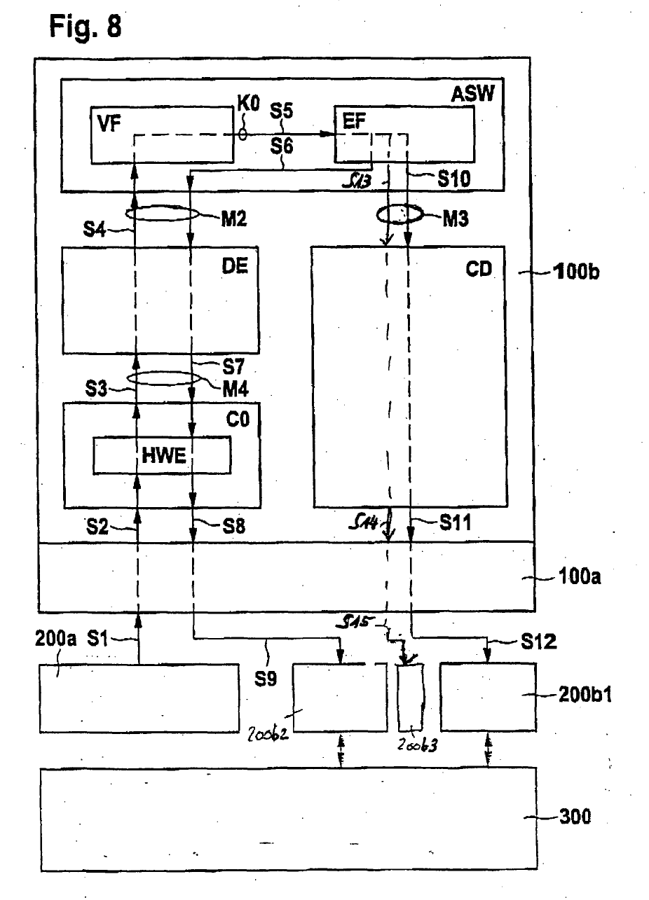

FIG. 6 illustrates, for example, module interfaces M2 and M4. The arrows represent in each case the dependencies implemented by the interfaces between the modules shown or their components. In this context, the statement that a module is dependent on an additional module or a component is a dependent on an additional component, means that this module accesses the additional module or this component accesses the additional component or that it gives the additional module or the additional component the task of processing data. The arrows representing the dependencies do not also necessarily represent the corresponding data flow directions; those are explained further in exemplary fashion with reference to FIG. 8. In FIG. 6 one may see that, between third module DE and first module ASW there is a reciprocal dependency. The dependency of first module ASW on third module DE, represented by the arrow, which is oriented from the second module to the first module, results from the fact that the first module has to rely on third module DE to make available, for instance, a sensor signal and/or an allocated quality signal, that represents information about the quality of the sensor signal, for first module ASW.

As may also be recognized from FIG. 6, fourth module interface M4 implements unilateral dependencies of the infrastructure component and the hardware capsule component with respect to third module DE, and a mutual dependency between communications component COM with respect to third module DE. All three components named are allocated to second module CO. The unilateral dependency of the infrastructure component and the hardware capsule component means that third module DE also accesses these components in order to have data processed there. Analogous dependency designations, as the ones just described for interface M4 between second module CO and third module DE, exists also for interface M6 between second module CO and fourth module CD.

FIG. 7 shows an example for a component-overlapping communication between two functional units in different components of the same module. More precisely, FIG. 7 shows a communication between functional unit signal preparation HWE-1 within hardware capsule component HWE and functional unit diagnosis manager IS-3 within infrastructure component IS. In this case, functional unit signal preparation is dependent on functional unit diagnosis manager. This may mean, for example, that functional unit signal preparation HWE-1 send a signal to functional unit diagnosis manager IS-3, with an instruction to process. The sent signal represents, for instance, a defect in hardware 100a that is allocated to control unit 100. With the transmission of the signal, functional unit signal preparation HWE-1 then instructs functional unit diagnosis manager to prepare this signal, which means, for example, to debounce, so that an error-free analysis of this signal becomes possible. Besides the signal preparation, functional unit diagnosis manager also is then given the task of storing this signal, so that, at a later point in time, for example in an auto repair shop, it may be read out for the purpose of error diagnosis.

Finally, FIG. 8 illustrates the cooperation between the individual modules within control unit software 100b in the light of an exemplary course of signals. Such a view of the course of the signals is an alternative possibility for describing the functions of individual interfaces, especially between the modules, as compared to the examination of dependencies that was mentioned above. The two ways of viewing it are in no way contradictory to each other, but simply describe the functions of an interface in a different manner.

In FIG. 8 there is specifically shown that signal course which comes about if the driver of a vehicle, in which the internal combustion engine 300 having control unit 100 is installed, operates the accelerator. The accelerator, or rather a position detector fastened to it, is represented in FIG. 8 by a reference symbol 200a as the sensor of sensor/actuator configuration 200. A signal S1, which represents the changed setting of the accelerator, is first input by the accelerator into hardware 100a of control unit 100. Within control unit hardware 100a, the real electrical sensor signal is converted into a software signal, which is at first still control unit-specific. This software signal S2 thereupon leaves control unit hardware 100a and is fed to second module CO, or to be more precise, into its hardware capsule component HWE. There, the software signal undergoes a preparation in such a way that the influences of control unit hardware 100a still contained in it are removed from it. At the output of hardware capsule component HWE there is then present a cleared-up software signal which, in particular, no longer includes any processor specifics. However, it still represents the characteristics of the original electrical signal, namely the changed accelerator setting, for instance, in the form of an amplitude of 3 V. This cleaned-up signal S3 is then supplied to third module DE via module interface M4. In third module DE, cleaned-up sensor signal S3 is prepared in such a way that it is converted to a physical level, with reference to the interface of the sensor to its surroundings. This may mean, for example, that physical signal S4 at the output of third module DE represents the changed setting of the accelerator represented by signal S3 at the input of the third module in the form of the 3 V amplitude as an actual variable, for instance, in the form of 75% of the possible rotary angle of the accelerator. Physical signal S4 is part of interface M2 between first module ASW and third module DE. The diagram goes from the third module directly into the first module, or more accurately speaking, into its vehicle component VF. Vehicle component VF interprets physical input signal S4 as a torque request for internal combustion engine 300. It coordinates this torque request from the third module with other torque requests that may be present, which are being by other modules, components or functional units to the internal combustion engine, in order, finally, to give out a resulting setpoint torque for the internal combustion engine in the form of signal S5 via component interface KO to drive assembly component EF.

Drive assembly component EF then executes a conversion of the setpoint torque received into physical variables that are dependent on the type of the internal combustion engine. If a Diesel engine is involved, for example, as internal combustion engine 300, assembly component EF generates a first actuating variable signal S6 which represents the physical setpoint injection pressure that is required for setting the required setpoint torque, as well as a second actuating variable signal S10, which represents the required setpoint fuel quantity on a physical level that is required for setting the specified setpoint torque. Depending on whether the generated actuating variable is provided for a normal actuator or a special actuator having a complex interface, drive assembly component EF passes the actuating variable to third module DE or to fourth module CD. In the example described so far, first actuating variable S6 is provided for activating a pressure regulating valve 200b2, which is a normal actuator not having a complex interface. Therefore, drive assembly component EF emits first actuating variable S6 via interface M2 to third module DE. The third module converts the input physical actuating variable S6 (software signal) into a software signal which represents the physical setpoint pressure in the form of an electrical signal S7 that is nonspecific for control unit hardware 100a. This signal S7 is emitted via module interface M4 to second module CO, where it is converted by ist hardware capsule component HWE into a software signal which represents an electrical signal that is specific for control unit hardware 100a. In this conversion, what may be involved is, for example, a quantization adjusted to the requirements of control unit hardware. Signal S8 generated by hardware capsule component HWE and emitted is supplied to control unit hardware 100a, which converts this signal into a real electrical signal for activating pressure regulating valve 200b2 as actuator.

In the example described, in parallel with the processing of first actuating variable signal S6, there takes place the processing of second actuating variable S10 by fourth module CD, after it was transmitted there via module interface M3. The fourth module converts signal S10, which represents the setpoint fuel quantity required for implementing the required setpoint torque in physical form, into a software signal, which represents a specific signal for control unit hardware 100a. This being the case, fourth module CD simultaneously takes on the function of the third module and of the hardware capsule component for special actuators having a more complex interface, as represented by a fuel injector 200b1 for setting the fuel quantity. Described software signal S11 that is emitted by fourth module CD is then also supplied to control unit hardware 100a, so that it converts the received software signal into a real electrical signal S12 for activating fuel injector 200b 1 as actuator. The activation thus taking place of pressure regulating valve 200b2 and of fuel injector 200b1 have the effect together of a change in torque of internal combustion engine 300, with regard to the driver command represented by the changed setting of the accelerator, or rather with regard to the setpoint torque representing this driver command

If a Diesel engine were not involved in the case of internal combustion engine 300, but rather a gasoline engine, three actuating variable signals would be generated by drive assembly component EF. First actuating variable signal S6, which is emitted to third module DE, represents a setpoint value for the air mass to be set, and second actuating variable signal S10 emitted to the fourth module represents the setpoint fuel quantity required for implementing the setpoint torque. In addition, a third actuating variable signal S13, is also emitted by drive assembly component EF to fourth module CD, actuating variable signal S13 specifying the ignition point for the sparkplugs of the internal combustion engine.

First actuating variable signal S6 is used, after a conversion into signals S7, S8 and S9, for activating the throttle valve, second actuating variable signal S10 is used, after a conversion into signals S11 and S12, in turn, for activating the fuel injector and third actuating variable signal S13 is used, after a conversion into signals S14 and S15, for activating a spark plug 200b3. The broken lines, drawn in FIG. 8 within the modules or components, illustrate only the allocations of input signals to output signals. They specifically do not exclude processing of input signals within the modules or components.

The functional units, components or modules are preferably implemented as computer programs. It is then possible to store these computer programs, possibly together with additional computer programs for controlling the drive assemblies, on a computer-readable data carrier. In this context, a disk, a compact disk, a so-called flash memory or the like may be involved. The software stored on the data carrier may then be sold to the customer as a product. In addition, in the case of a software implementation, it is possible to transmit the computer program as a product to the customer and to sell it in that manner, again, possibly, together with additional computer programs, even without the aid of a data carrier but via an electronic communications network. The communications network may, for instance, be the Internet.

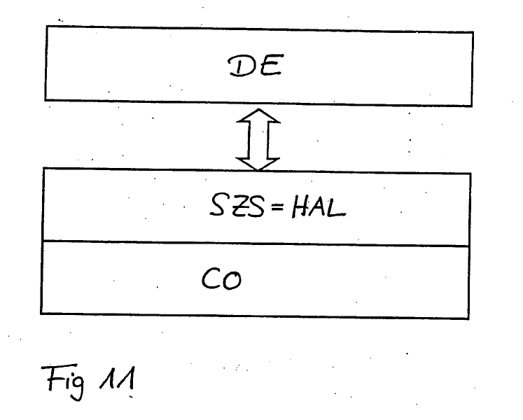

In one specific broadening of the specific embodiments described up to now, we now specifically emphasize the configuration and allocation of the input and output signals of the modules, especially DE and CO as well as their descriptions. In this context, an intermediate module or an intermediate layer SZS is introduced, which makes possible the allocation of the signals between the modules, especially CO and DE. This is shown in FIG. 10. In this figure, modules CO, CD, DE, ASW are shown again that have already been described. Between modules CO and DE, a specific interface is now shown, for structuring configuration data, the so-called configuration interface KSS. This includes component a routing module for signal allocation, that is, a signal allocation layer SZS. This SZS is allocated to the layer closer to the hardware, that is, to module CO. Furthermore, a requirement module or a requirement layer AS is allocated to module DE. Because of this SZS or the entire KSS, a general and flexible signal allocation is now able to take place, so that module CO and model DE may be conceptualized independently of their input and output signals or their specific system, exchanged with each other, since the correct signal allocation takes place in an intermediate layer, the module SZS.

In a selected representation, there takes place the configuration of modules, advantageously via an XML description of the configuration parameters which are translated by configuration generators into corresponding *.c and *.h data files. This document describes the configuration of the software package digital input/output (DIO) via XML-based text files. In these XML data files, among other things, the properties of the signal class DIO are defined. The description of the DIO properties is carried out at various working levels. On the one hand, the DIO signals are requested by the project-independent device encapsulation (DE) having the parameters direction, initializing value and applicability (DIO_SIGNAL_REQUEST), and on the other hand, these signals have to be projected onto the specific application, i.e. the signals have to be routed to the appropriate hardware (DIO_SIGNAL_ROUTING). Requested hardware pins are likewise be configured (DIO_SIGNAL_IMPLEMENT).

### Description on Different Configuration Levels

When describing digital input and output signals, a distinction is made between device encapsulation (DE), hardware abstraction layer (HAL=SZS) and hardware configuration (module CO). However, this device is also found between further layers or may be used the same way between the remaining modules. Optionally, for example between ASW and CO as KSS3, or ASW and DE as KSS4, or ASW and CD as KSS5, as well as between CD and DE as KSS2. In this context, as in the case of KSS, there is always included the output module as CO, in this instance, as hardware configuration, a target module as DE at KSS having a request module or a request layer AS, and an allocation layer or a routing module SZS. This basic structure is also transferable to the remaining configuration interfaces KSS2 through KSS5. Subsequently, we shall only correspondingly describe KSS, that is, CO and DE, the applicability thereby of the remaining interfaces KSS2-KSS5 are regarded as being similarly illustrated.

The relevant configuration parameters for the component driver of DE may be represented in the abstract and independent of a project. In the case of digital input signals and output signals, on this level, for example, the signal name, the direction and the initializing value are of interest. In this context, from the point of view of the component driver, it makes no difference (assuming that the boundary conditions are kept) on which hardware the component driver is later to run.

The configuration of HAL includes the routing of the signal name to the corresponding hardware. In this layer, a generic hardware pin name is assigned to the signal.

The hardware-specific configuration settings are undertaken at the lowest level. The configuration parameters of this level refer to the corresponding module or to the signal class, and should no longer be viewed as project-independent and hardware-independent. The assignment of the signals takes place via statement of the hardware module (e.g. ADC, GPIO or CY310, CY100, etc) along with the desired port or pin on this module. In the case of the ADC module, in addition, the threshold voltage has to be given that makes the decision of high or low.

The setting of register values takes place via the configuration of the port hardware layer (the layer). On this level, requests come together that overlap the modules. For example, for the parallel interface, there exist requests from various modules or signal classes (GPIO, GPTA, SSC, CAN, etc). For this reason, hardware settings are not able to take place in a module-specific manner in a signal class (see also configuration process).

Thus the DIO configuration takes place on different configuration levels:
device encapsulation (DE): request for a signal
hardware encapsulation/HAL=SZS: routing of a signal
hardware configuration CO: configuration of the hardware layer.

### The Three Layers of the Configuration

### Layer/Data File/Content

### DE/packetname.xml/signal name, direction (IN, OUT), applicability or setting of the type of access (macro or function)

### HAL(routing)/project.xml/signal name, hardware module, port, pin, [THRESHOLD VALUE_{(ADC)}]

### Hardware Configuration/hardware.xml/hardware properties/register settings

The subdivision of the configuration into various levels is not limited just to the configuring of digital input and output signals or of the DIO module, but also in other modules (ADC, PWM) there takes place the configuration corresponding to the above classification, including possible deviations.

The names of the XML configuration data files are basically freely selectable. Within DE, certainly a plurality of packet-oriented configuration data files will be created. On the HAL level, the signal routing may be distributed either into a central XML data file or to various configuration data files. In this connection, it will be seen which subdivision is most suitable for structuring of the project-specific configuration. The same applies to the setting of the hardware or the register configurations.

```
Request for a Signal
XML Description for DIO (Packet Layer - DE)
<CONF>
    <DIO>
        <DIO>_SIGNAL_REQUEST>
            <DESC>Break signal</DESC>
            <DIO SIGNAL NAME>E A BRK</DIO SIGNAL NAME>
            <DIO DIR>IN</DIO DIR>
            <DIO CALIBRATION>YES</DIO CALIBRATION>
            <DIO INIT>HIGH</DIO INIT>
        </DIO SIGNAL REQUEST>
    </DIO>
</CONF>
```

At this level, a signal is requested, from DE, on the part of the packet.

Each packet may create one or more XML data files having any desired data file name, and may request or reserve input signals and output signals from the Core/Hwe/Dio module. For this, the packet syntax is copied from the XML description for DIO (Packet layer—DE) into this(these) XML data file(s) and customized.

In the above example it is determined that a signal named “E_A_BRK” in packet “IN” is being used, that it has a certain direction (here “IN” for input) and that it is applicable (applicable means that the signal routing takes place during running time in the light of a signal table, and consequently it is able to be changed during operation. If the signal data are created exclusively at compile time, then the signals may no longer be alternate-routed) or not (here “YES” for applicable). The configuration of various signals may be repeated any number of times in an XML data file.

### Comment:

The tags DIO_CALIBRATION and DIO_INIT are optional tags. These should only be specified if, from the DE layer, there exist beforehand requests on type of access or initialization. A command on configuration is what is involved with these tags. If deviating settings are undertaken on the HW level, the requests from the DE layer are overwritten and also logged in the report data file (see also dump from the data file tmp/include_tmp/dio_report.txt).

```
Routing of a Signal
XML Description for DIO (Project Layer.HAL)
<CONF>
    <DIO>
        <DIO SIGNAL ROUTING>
            <DESC>Break signal</DESC>
            <DIO_SOURCE>E_A_BRK</DIO SOURCE >
            <DIO_TARGET > GPIO_{—} PS_{—} PO_{—} IN
            < / DIO_TARGET>
        </DIO SIGNAL ROUTING>
    </DIO>
</CONF>
```

The project carries out the signal routing on this level. The software signal name is, so to speak, assigned to the hardware pin name. This hardware pin name comes about from the desired hardware resource that is configured in the hardware layer (see configuration of the hardware layer).

As an example from the XML description for DIO (project layer.HAL), it is determined that a signal having the name “E_A_BRK” in packet “DIO” having the description (DESC) “Break signal” is being used, and that it is to be assigned to a certain hardware pin name “GPIO_P8_P0_IN” (port “8”, pin “0”, direction “IN”), (“GPIO” stands for access to parallel interface). The configuration of various signals may be repeated any number of times in an XML data file.

```
Configuration of the Hardware layer
XML Description for DIO (Project Layer)
<CONF>
    <DIO>
        <DIO SIGNAL IMPLEMENT>
            <DESC>hardware resource for break signal</DESC>
            <DIO MODULE>GPIO</DIO MODULE>
            <DIO PORT>8</DIO PORT>
            <DIO PIN>0</DIO PIN>
            <DIO DIR>IN</DIO DIR>
            <DIO CALIBRATION>YES</DIO CALIBRATION>
            <DIO_INIT>HIGH</DIO_INIT>
        </DIO SIGNAL IMPLEMENT>
    </DIO>
</CONF>
```

The hardware properties of TC1775/TC1796 are separated from the functional settings and specified in a separate configuration layer (HW layer).

Each project is able to create one or more XML data file(s) having any name and allocate certain properties to modules as well as their ports and pins (output stages and pins). These modules have to be functionally in a position to read and emit digital signals. For this, the syntax has to be copied from the XML description for DIO (hardware layer) into this(these) XML data file(s) and customized.

In the above example it is determined that a module having the name “GPIO” in packet “DIO” having the description (DESC) “GPIO_P8_P0_IN” is being used (“GPIO” stands for parallel interface). The resource (port “8”, pin “0”) is requested by this module and assigned to application identifier “YES” as well as to the initializing value “HIGH” (provided this makes sense at this point for an input). The configuration of various signals may be repeated any number of times in an XML data file.

### Generic Hardware Pin Name

The hardware pin name is a purely generic name which is uniquely assigned to a hardware resource, and is made up according to the following pattern.

<module name>_P<port number>_P<pin number>_<direction>
e.g GPIO_P8_P0_IN.

The hardware pin name may be taken from the DIO report data file after a configuration run (see below, Generic Hardware Pin Name).

### Dump from Data File tmp/include tmp/dio report.txt

### DIO Report

### Signal Map—Digital Input/Output Signals

### Signal Name: OUTPUT

HW Signal: GPIO_P9_PO_OUT
Modules: GPIO
Port: 9
Pin: 0
Calibration: YES

### Signal Name: INPUT

HW Signal: GPIO_P9_P4_IN Module: GPIO
Port: 9 Pin. 4 Calibration: YES
Signal name: INPUT2
HW Signal: GPIO_P9_P8_IN Module: GPIO
Port: 9 Pin. 8 Calibration: YES

### Signal Name: INPUT2

HW Signal: GPIO_P9_P8_IN
Modules: GPIO
Port: 9
Pin: 8
Calibration: YES

### Comments

It becomes clear that the XML elements <DIO_CALIBRATION> and <DIO_INIT> occur in respectively two different layers. Both XML elements are optional, i.e. in case these are not explicitly given, one may assume the following default setting:

### <DIO CALIBRATION>NO</DIO CALIBRATION>

### <DIO INIT>LOW</DIO INIT>

If these XML elements occur both in the DE layer (request for a signal), and in the configuration of the hardware layer, the settings in the hardware layer have a higher priority on the project level. In saying this, we assume that the project level is able to undertake specific settings and carry them out with respect to the DE layer. Possible overlappings are also logged and may be inspected after the configuration run.

### Registration of the XML Configuration Data File

After carrying out the configuration according to the request of a signal and the routing of a signal, the stored XML data files have to be entered into the respective makefiles under the element CONF, see Mapping 5: Makefile having entered XML configuration data file. Makefile having entered XML configuration data file.

| Makefile Having Entered XML Configuration Data File | |
|---|---|
| #----------------------------------------------------------- | |
| Module definition | |
| #----------------------------------------------------------- | |
| NAME | : = dio |
| INTERFACE | : = dio.h. |
| CONF | : = dio_request.xml dio_routing.xml |
| | dio_implement.xml |
| CSOURCES | : = dio.c gpio.c |
| ASMSOURCES | : = |
| IMPLEMENTATION | : = |
| DATA | : = |
| SUBDIRS | : = |
| | : = diocfg |

### Input of the Configuration Data

The input of the configuration data is made via an XML browser (e.g. XMetal). The XML structure is preset in the light of a document type definition (DTD) for the configuration of the miniproject. The DTD for the configuration of the miniproject lies in edc_hwe_vob in the miniproject under \scripts\xml\medc17_conf.dtd.

This DTD is being successively upgraded corresponding to the configurable data made available, by the developers of the core packets (modules) The XML configuration data files have to be validated via these DTD.

### Configuration Process

On account of the subdivision into various configuration levels it is possible, without detailed knowledge about the configuration manner of other layers, to make settings on different levels.

In this context, only the configuration parameters have to be given which are actually relevant for the layer to be configured.

The corresponding layer model is illustrated in FIG. 11.

In the light of the description of digital input and output signals, this process can be very easily explained. In the uppermost layer (DE) a signal request is made to signal class DIO. Besides the direction, the initializing value and the parameter applicability, it is the signal name via which the request from DE is linked to the routing in HAL. In HAL, the signal name may now be routed to the appropriate resource. The mapping with the settings in HWL takes place via the signal name or hardware pin name of the pin. In the hardware layer, besides the module name, the corresponding port or pin has to be given also. The properties for the PORT hardware, such as the register settings, are attended to separately via the PORT configuration. The configuration of the individual layers is distributed, as a rule, to various XML data files. The configuration generators have the task of checking the configured data and to validate them.

### Configuration Generators

After the call of the “make” or “make xml2conf” command in the miniproject, a data file list for the opened configuration data files is generated in the light of the registered XML configuration data files. Based on this, the central XML parser for the configuration (formerly core_parse.pl) gathers all configuration data files and data. Following the parsing process, the individual configuration generators are started, and the corresponding *.c and *.h configuration data files are generated.

In addition, the configuration generators check the consistency of the data and validate the user data. After the successful conclusion of the “makerun”, the configured signals may be used in the control unit code.

1.-9. (canceled)

10. A control unit, comprising:
at least one processor;
at least one memory element for controlling a drive assembly;
a sensor/actuator configuration connected between the at least one processor and the drive assembly and via which the at least one memory element controls the drive assembly;
a first module;
a second module; and
a signal allocating layer, wherein:
a control occurs by a communication between a plurality of functional units filed in the at least one memory element,
the first module is closer to the at least one processor than the second module,
the first module is connected to the second module via the signal allocating layer, and
the signal allocating layer allocates digital signals of the first module to the second module.

11. The control unit as recited in claim 10, further comprising:
a third module that combines functional units for influencing the drive assembly in response to a user command on a physical level.

12. The control unit as recited in claim 10, wherein:
the first module combines functional units for making possible individual programming of the at least one processor so that the at least one processor communicates with the first module and the second module, the functional units coordinating in time a processing of functions of the functional units,
the second module combines functional units for making possible an individual adjustment of the sensor/actuator configuration to the control unit in such a way that, between individual sensors or actuators of the sensor/actuator configuration, communication is possible with remaining modules of the control unit, and
between the first module and the second module, module interfaces are provided for a module-overlapping communication.

13. The control unit as recited in claim 11, wherein the third module includes:
a vehicle component that combines functional units that are not specific for a type of drive assembly that is used, and
a drive assembly component that combines functional units that are specific for the type of drive assembly that is used.

14. The control unit as recited in claim 11, wherein the first module includes:
an infrastructure component that combines functional units that one of offer and represent basic services accessible by other functional units, and
a hardware capsule component that combines functional units for individually programming hardware of the control unit in such a way that the hardware is put in a position to communicate with at least one of the first module and the second module.

15. The control unit as recited in claim 14, wherein the infrastructure component includes at least one of a functional units services library, a sequence control system, a diagnosis manager, and a monitoring concept.

16. The control unit as recited in claim 14, further comprising:
a fourth module that combines functional units for directly activating the sensor/actuator configuration, wherein the sensor/actuator configuration includes complex interfaces to the control unit by the third module.

17. The control unit as recited in claim 11, wherein at least one of the functional units, components, and the modules, including interfaces therebetween, are developed at least partially as a computer program.

18. A computer program for a control unit for controlling a drive assembly of a vehicle, comprising:
a program code that is suitable for mapping one of functional units, components, and modules and for implementing communication therebetween, for the purpose of controlling the drive assembly.

19. The control unit as recited in claim 10, wherein the drive assembly includes an internal combustion engine of a vehicle.
